(19) United States
(12) Patent Application Publication
(10) Pub. No.: US 2025/0039831 A1
(43) Pub. Date: Jan. 30, 2025

(54) Methods And Apparatus For Periodic Reporting Of Location Information With Multiple Quality-Of-Service Criteria In User Equipment Positioning

(71) Applicant: MediaTek Inc., Hsinchu City (TW)

(72) Inventors: Jian-Nong Li, Hsinchu City (TW); Nathan Edward Tenny, San Jose, CA (US)

(21) Appl. No.: 18/772,109

(22) Filed: Jul. 13, 2024

Related U.S. Application Data
(60) Provisional application No. 63/515,845, filed on Jul. 27, 2023.

(51) Int. Cl. H04W 64/00

(52) U.S. Cl. CPC H04W 64/00

(57) ABSTRACT

Various solutions for periodic reporting of location information with multiple quality-of-service (QOS) criteria in user equipment (UE) positioning are described. An apparatus, such as a UE, may receive a request for location information from a location server. The request includes a plurality of accuracy criteria and a periodic reporting configuration. Then, the apparatus may determine one or more location estimates, each of which satisfies a least stringent one of the accuracy criteria. The apparatus may further report the one or more location estimates to the location server based on the periodic reporting configuration.

### CROSS REFERENCE TO RELATED PATENT APPLICATION(S)

The present disclosure is part of a non-provisional application claiming the priority benefit of U.S. Provisional Patent Application No. 63/515,845, filed 27 Jul. 2023, the content of which herein being incorporated by reference in its entirety.

### TECHNICAL FIELD

The present disclosure is generally related to mobile communications and, more particularly, to periodic reporting of location information with multiple quality-of-service (QoS) criteria in user equipment (UE) positioning.

### BACKGROUND

Unless otherwise indicated herein, approaches described in this section are not prior art to the claims listed below and are not admitted as prior art by inclusion in this section.

In wireless communications, such as mobile communications under the 3^{rd} generation partnership project (3GPP) standards including 4^{th} generation (4G) long-term evolution (LTE) and 5^{th} generation (5G) new radio (NR), UE positioning generally requires network involvement to estimate the location of a UE. Under current framework of UE positioning, when a location services (LCS) session is triggered by a client towards a cellular network, the client may transmit a positioning request including a QoS requirement to a node of the cellular network. A typical QoS criteria for positioning may include a horizontal accuracy, a vertical accuracy, and a maximum time to fix, etc. By the positioning request, a location server in the cellular network is expected to return a location estimate that meets the QoS criteria, or to indicate an error/failure condition to the client if it is unable to obtain an eligible location estimate. Alternatively, the client may provide a positioning request with multiple sets of QoS criteria (also referred to as QoS classes), and the location server may take care of the UE positioning attempts until an eligible location estimate is obtained. In addition, it is observed that UE positioning accuracy (e.g., using global positioning system (GPS)) would be affected due to signal reflection and blockage, especially in indoor environments. Consequently, frequent UE positioning attempts may cause increase in signaling overhead and decrease in positioning efficiency.

Accordingly, how to enhance UE positioning becomes an important issue for modern wireless communication systems. Therefore, there is a need to provide proper schemes to address this issue.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is proposing schemes, concepts, designs, systems, methods and apparatus pertaining to periodic reporting of location information with multiple QoS criteria in UE positioning. It is believed that the above-described issue would be avoided or otherwise alleviated by implementing one or more of the proposed schemes described herein.

In one aspect, a method may involve a processor of an apparatus (e.g., a UE), receiving a request for location information from a location server (e.g., a location management function (LMF) or a secure location platform (SLP)), wherein the request comprises a plurality of accuracy criteria and a periodic reporting configuration. The method may also involve the processor determining one or more location estimates, each of which satisfies a least stringent one of the accuracy criteria. The method may further involve the processor reporting the one or more location estimates to the location server based on the periodic reporting configuration.

In one aspect, an apparatus (e.g., a UE) may include a transceiver which, during operation, wirelessly communicates with a wireless network comprising a location server (e.g., an LMF or an SLP). The apparatus may also include a processor communicatively coupled to the transceiver. The processor, during operation, may perform operations including receiving, via the transceiver, a request for location information from the location server, wherein the request comprises a plurality of accuracy criteria and a periodic reporting configuration. The processor may also perform operations including determining one or more location estimates, each of which satisfies a least stringent one of the accuracy criteria. The processor may further perform operations including reporting, via the transceiver, the one or more location estimates to the location server based on the periodic reporting configuration.

In one aspect, a method may involve a processor of a location server (e.g., an LMF or an SLP), receiving a first request for positioning an apparatus (e.g., a UE) from an LCS client, wherein the first request comprises a plurality of QoS criteria. The method may also involve the processor transmitting a second request for location information to the apparatus, wherein the second request comprises a plurality of accuracy criteria. The method may further involve the processor receiving one or more location estimates from the apparatus, wherein each of the one or more location estimates satisfies a least stringent one of the accuracy criteria. The method may then involve the processor transmitting at least one of the one or more location estimates to the LCS client.

It is noteworthy that, although description provided herein may be in the context of certain radio access technologies, networks and network topologies such as Long-Term Evolution (LTE), LTE-Advanced, LTE-Advanced Pro, 5^{th} Generation (5G), New Radio (NR), Internet-of-Things (IoT) and Narrow Band Internet of Things (NB-IoT), Industrial Internet of Things (IIoT), and 6^{th} Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with the present disclosure may be implemented.

FIG. 2 is a diagram depicting an example scenario of a mobile-terminated location service in accordance with an implementation of the present disclosure.

FIG. 3 is a diagram depicting an example scenario of a periodic or event-triggered reporting procedure in accordance with an implementation of the present disclosure.

FIG. 4 is a diagram depicting an example scenario of a positioning procedure with multiple QoS criteria in accordance with an implementation of the present disclosure.

FIG. 5 is a diagram depicting an example scenario of a positioning procedure with multiple QoS criteria in accordance with another implementation of the present disclosure.

FIG. 6 is a diagram depicting an example scenario of a positioning procedure with multiple QoS criteria in accordance with another implementation of the present disclosure.

FIG. 7 is a block diagram of an example communication system in accordance with an implementation of the present disclosure.

FIG. 8 is a flowchart of an example process in accordance with an implementation of the present disclosure.

FIG. 9 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to periodic reporting of location information with multiple QoS criteria in UE positioning. According to the present disclosure, a number of possible solutions may be implemented separately or jointly. That is, although these possible solutions may be described below separately, two or more of these possible solutions may be implemented in one combination or another.

In current framework of UE positioning, an LCS client may initiate an LCS session by transmitting a positioning request with one or multiple sets of QoS criteria to a location server. For example, when an LCS client provides a positioning request with multiple sets of QoS criteria, the semantics of such a request may be interpreted as the LCS client requesting a first QoS (e.g., more stringent accuracy) preferentially, but also indicating that it will accept a second QoS (e.g., less stringent accuracy). Additional QoS criteria may be provided as well, e.g., as intermediate requested levels of accuracy. The expected behavior is then for the location server to attempt UE positioning for several times (if necessary) until at least one of the requested QoS criteria is met. One possible server implementation would be to send a first location request targeting a first QoS requirement/criterion (e.g., a more stringent accuracy criteria); if the first location request fails, to send a second location request targeting a second QoS requirement/criterion (e.g., a less stringent accuracy criteria); if the second positioning request fails, to send a third location request targeting a third QoS requirement/criterion (e.g., a still less stringent accuracy criteria); and so on until one of the QoS requirements/criteria is met, a deadline (i.e., maximum response time) for delivering the location estimate expires, or the location server determines that it is unable to meet any of the requested QoS criteria. Consequently, frequent UE positioning attempts may cause increase in signaling overhead and decrease in positioning efficiency.

In view of the above, the present disclosure proposes a number of schemes pertaining to periodic reporting of location information with multiple QoS criteria in UE positioning. Under the schemes of the present disclosure, the location server may transmit a single location request including a plurality of requested QoS criteria to a mobile device (e.g., a UE) to be positioned, and the mobile device may perform periodic reporting (also called periodical reporting) while the mobile device's estimate of its own position converges. Accordingly, by applying the schemes of the present disclosure, UE positioning with simplified and efficient signaling frameworks may be realized.

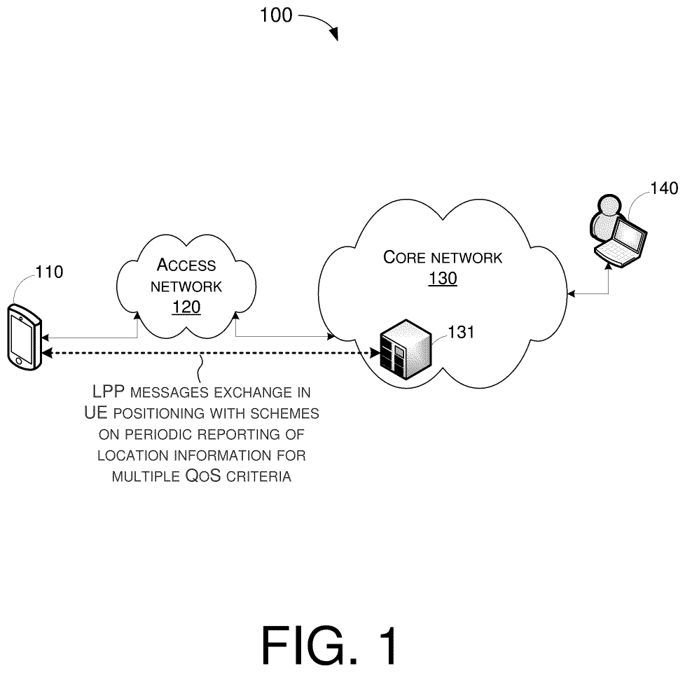

FIG. 1 illustrates an example scenario 100 of a communication environment in which various solutions and schemes in accordance with the present disclosure may be implemented. Scenario 100 involves a UE 110 in wireless communication with a wireless network (e.g., a 4G/5G/B5G/6G network or an IoT/NB-IoT/IIot network) including an access network 120 (e.g., a terrestrial network (TN) and/or a non-terrestrial network (NTN)) and a core network 130, and an LCS client 140 in connection (e.g., via Internet) with the core network 130 to trigger/initiate LCS session(s) with a location server 131 in the core network 130 for positioning the UE 110. The access network 120 may include at least a TN (or called a radio access network (RAN)) node (e.g., a base station (BS) such as an evolved Node-B (eNB), a Next Generation Node-B (gNB), or a transmission/reception point (TRP), or a (wireless-fidelity) access point (AP)) and/or at least an NTN node (e.g., a satellite). In one example, for a 5G system (5GS), the core network 130 may be a 5G core (5GC) including an access and mobility management function (AMF), a location management function (LMF) serving as the location server 131, and a gateway mobile location center (GMLC), etc. In another example, for a 4G system (4GS), the core network 130 may be an evolved packet core (EPC) including a mobility management entity (MME), a serving gateway (S-GW), a secure location platform (SLP) serving as the location server 131, and a packet data network gateway (P-GW), etc. In such communication environment, the UE 110, the access network 120, the core network 130, and the LCS client 140 may implement various schemes pertaining to periodic reporting of location information with multiple QoS criteria in UE positioning in accordance with the present disclosure, as described below. Particularly, the UE 110 and the location server 131 (potentially together with the access network 120) may instantiate a positioning session which allows the UE 110 and the location server 131 to exchange messages of a positioning protocol such as the LTE positioning protocol (LPP). The establishment of the positioning session may or may not involve explicit signaling between the UE 110 and the location server 131. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

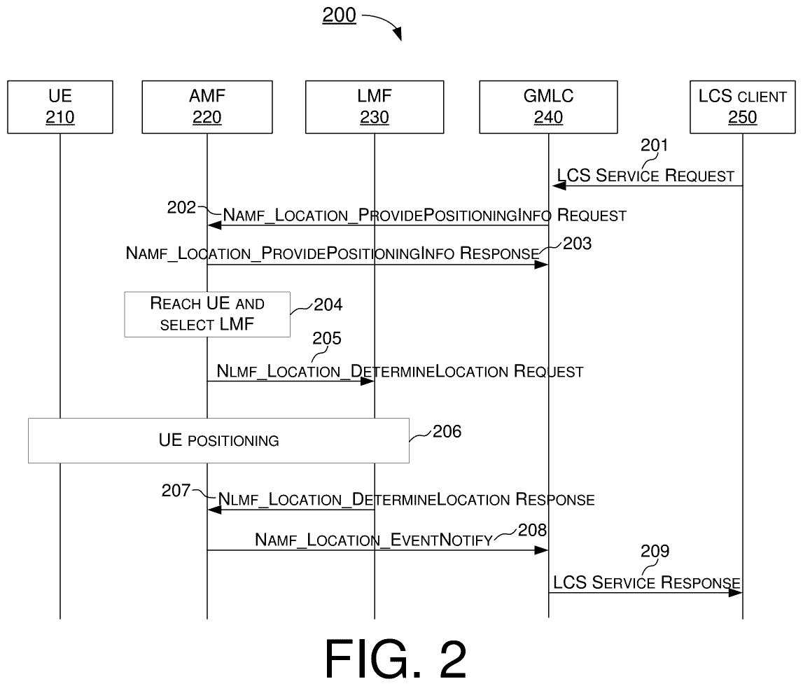

FIG. 2 illustrates an example scenario 200 of a mobile-terminated location service in accordance with an implementation of the present disclosure. Scenario 200 depicts an exemplary message sequence chart of a deferred mobile-terminated (MT) location request (LR) procedure involving a UE 210, an AMF 220, an LMF 230, a GMLC 240, and an LCS client 250. It is noteworthy that the LMF 230 in FIG. 2 represents a location server generally, and that substantially the same or similar procedure may apply to 4GS if the location server is an SLP. That is, in the present disclosure, examples that discuss an LMF should be understood to be applicable to another type of location server, such as an SLP. It is also noted that some steps of the deferred MT-LR procedure are omitted in FIG. 2, such as a facility for event-triggered reporting, and FIG. 2 shows a non-roaming scenario (meaning, for example, that there is only one GMLC in the figure, rather than a home GMLC and a visited GMLC). In step 201, the LCS client 250 transmits an LCS service request to the GMLC 240. The LCS service request may include a request for a location estimate that meets one or more QoS requirements. In step 202, the GMLC 240 transmits, to the AMF 220, a request of an Namf_Location_ProvidePositioningInfo service offered by the AMF 220. In step 203, the AMF 220 transmits a response of the Namf_Location_ProvidePositioningInfo service to the GMLC 240. In step 204, the AMF 220 ensures that the UE 210 is reachable (e.g., by triggering a paging procedure to bring the UE 210 from an idle state to a connected state if necessary) and selects an LMF (e.g., the LMF 230) to handle the positioning operation.

Subsequently, in step 205, the AMF 220 transmits a request of an Nlmf_Location_DetermineLocation service to the LMF 230, wherein the request (or called a location request) may include a request for a location estimate along with information indicating the one or more QoS requirements that are expected to be met. In step 206, the LMF 230 and the UE 210 (and potentially a RAN which is not shown in FIG. 2) carry out a UE positioning procedure. The UE positioning procedure may be a multi-stage process, and the details will be explored later in the present disclosure. In step 207, the LMF 230 transmits a response of the Nlmf_Location_DetermineLocation service to the AMF 220, wherein the response may include a location estimate, an achieved accuracy of the location estimate, and/or an error indication in case the location estimate did not meet the QoS criteria, etc. In step 208, the AMF 220 transmits an invocation of an Namf_Location_EventNotify service to the GMLC 240, to indicate the location result (and/or the achieved accuracy, any error indication, and/or other related information) to the GMLC 240. In step 209, the GMLC 240 transmits an LCS service response to the LCS client 250, to inform the LCS client 250 of the result of the positioning operation.

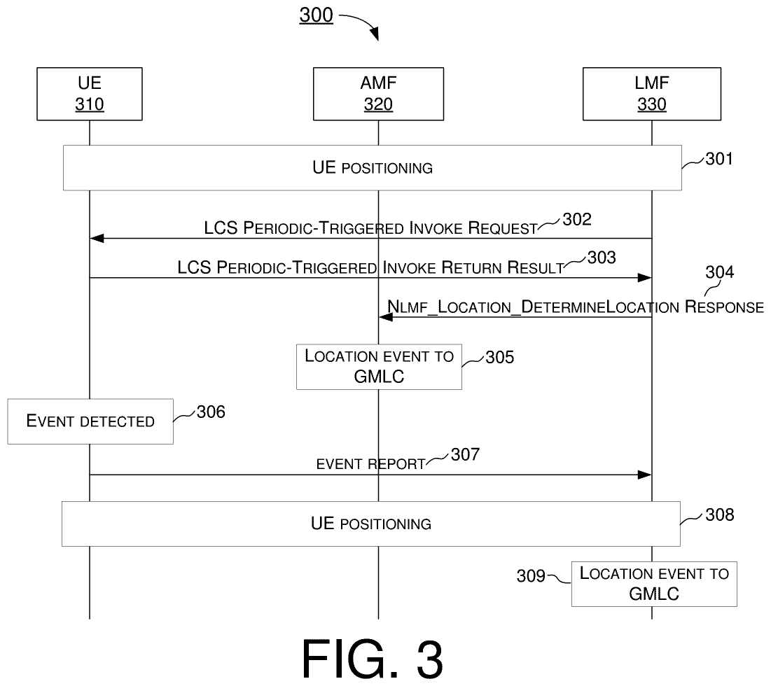

FIG. 3 illustrates an example scenario 300 of a periodic or event-triggered reporting procedure in accordance with an implementation of the present disclosure. Scenario 300 depicts an exemplary message sequence chart of a periodic or event-triggered reporting procedure involving a UE 310, an AMF 320, and an LMF 330. It is noteworthy that periodic reporting may be considered as a special case of event-triggered reporting, in which the “event” is the expiration of a timer controlling the periodic reporting. In step 301, the LMF 330 and the UE 310 (perhaps along with a RAN which is not shown in FIG. 3) perform a UE positioning procedure, similar to step 206 of FIG. 2. In step 302, the LMF 330 transmits an LCS periodic-triggered invoke request to the UE 310. For example, the LCS periodic-triggered invoke request may be a supplementary services (SS) message. In step 303, the UE 310 transmits an LCS periodic-triggered invoke return result to the LMF 330. The LCS periodic-triggered invoke return result may represent a first instance of location reporting or may simply indicate that the periodic or event-triggered location operation was successfully configured. In step 304, the LMF 330 transmits a response of an Nlmf_Location_DetermineLocation service to the AMF 320. In step 305, the AMF 320 transfers the results of steps 303 and 304 to the GMLC (which is not shown in FIG. 3). In step 306, the UE 310 detects an event triggering location reporting, which may, for instance, be the expiration of a timer controlling periodic reporting. In step 307, the UE 310 transmits an event report, which may be an SS message, to the LMF 330. In step 308, a UE positioning operation is performed. It is noteworthy that this figure shows the UE positioning operation as involving the UE 310 and the LMF 330, but in some cases the actual positioning processing may take place only at the UE 310. For example, if the UE 310 was configured to perform UE-based positioning and report periodically, the LMF 330 may not need to configure the UE 310 with any additional information in step 308. The outcome of step 308 is that the LMF 330 receives location information (for example, positioning measurements or a location estimate) from the UE 310. In step 309, the LMF 330 indicates the triggering of a location event to the GMLC (not shown), which may include, for example, any location estimate determined in step 308.

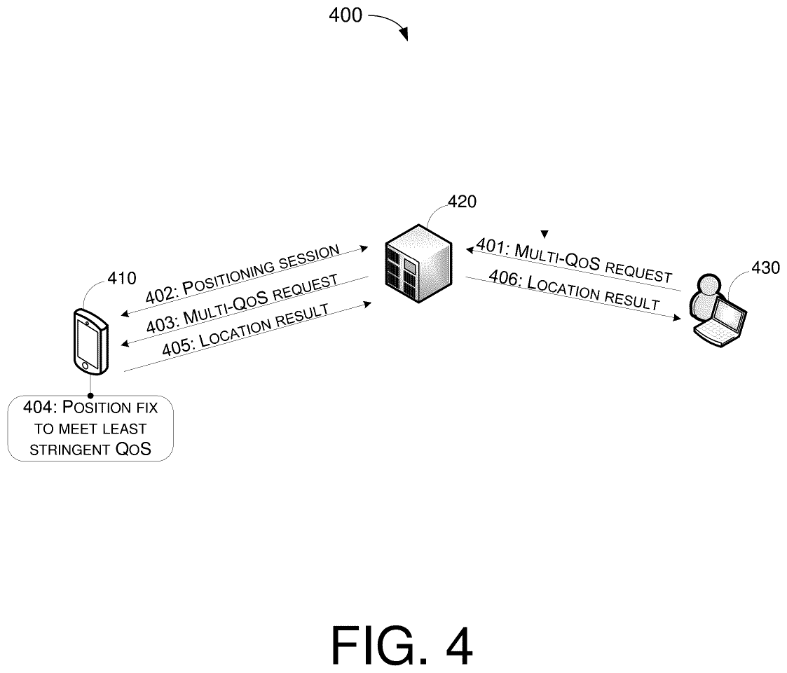

FIG. 4 illustrates an example scenario 400 of a positioning procedure with multiple QoS criteria in accordance with an implementation of the present disclosure. Scenario 400 depicts an exemplary message sequence chart of a positioning procedure involving a UE 410 computing a location estimate that meets a least stringent one of multiple sets of QoS criteria from an LMF 420 and an LCS client 430. This procedure may also be described as an example of a “lazy UE problem”, in the sense that the UE 410 exploits the multiple QoS criteria to reduce the amount of work it performs for the positioning operation at the expense of location accuracy. In step 401, the LCS client 430 transmits a request for positioning with multiple sets of QoS criteria to the LMF 420. It is noteworthy that step 401 is a simplification for the sake of clarity in this figure and this single step actually represents successive communications between the LCS client 430 and a GMLC (which is not shown in FIG. 4), then between the GMLC and an AMF (which is not shown in FIG. 4), then between the AMF and the LMF 420, as previously described in steps 202 to 205 of FIG. 2. In step 402, the LMF 420 and the UE 410 (potentially together with a RAN, which is not shown in FIG. 4) initiate a positioning session. This session may, for example, allow the LMF 420 and the UE 410 to exchange messages of a positioning protocol such as the LPP, and the establishment of the session may or may not involve explicit signaling between the LMF 420 and the UE 410. In step 403, the LMF 420 transmits to the UE 410 a request for location information (e.g., an LPP Request Location Information message) including multiple QoS criteria, reflecting the multiple QoS criteria from step 401. More specifically, the multiple QoS criteria may include a least stringent accuracy requirement and a most stringent accuracy requirement. The request for location information may include a request for the UE 410 to compute/determine its own location (UE-based positioning).

Subsequently, in step 404, the UE 410 performs positioning operations to compute/determine a location estimate. In this example, the UE 410 performs measurements and computations only to the point of meeting the least stringent one of the accuracy criteria from the QoS configuration in step 403. This design may be advantageous to the UE 410, in that it reduces processing and measurement effort and may save battery power, but it results in a less accurate location estimate if the UE 410 was able to meet a more stringent one (e.g., the most stringent one) of the multiple QoS criteria. In step 405, the UE 410 reports its location result to the LMF 420. The LMF 420 considers this location result as a valid response to step 403, since the location estimate meets one of the QoS criteria from step 403. In step 406, the LMF 420 delivers the location result to the LCS client 430. Similar to step 401, step 406 is simplified to elide interactions with an AMF and a GMLC, wherein the procedural effect of these interactions is to deliver the location estimate from the LMF 420 via other nodes/entities to the LCS client 430. It is noteworthy that the LCS client 430 may be expected to accept the location estimate as a valid response to the request from step 401, because the location estimate meets one of the QoS criteria from step 401. However, because the UE minimized its processing effort by meeting only the least stringent accuracy requirement, the accuracy of the location estimate may be poorer than desired by the LCS client 430 and also poorer than the UE 410 could have achieved with more measurement and/or computation.

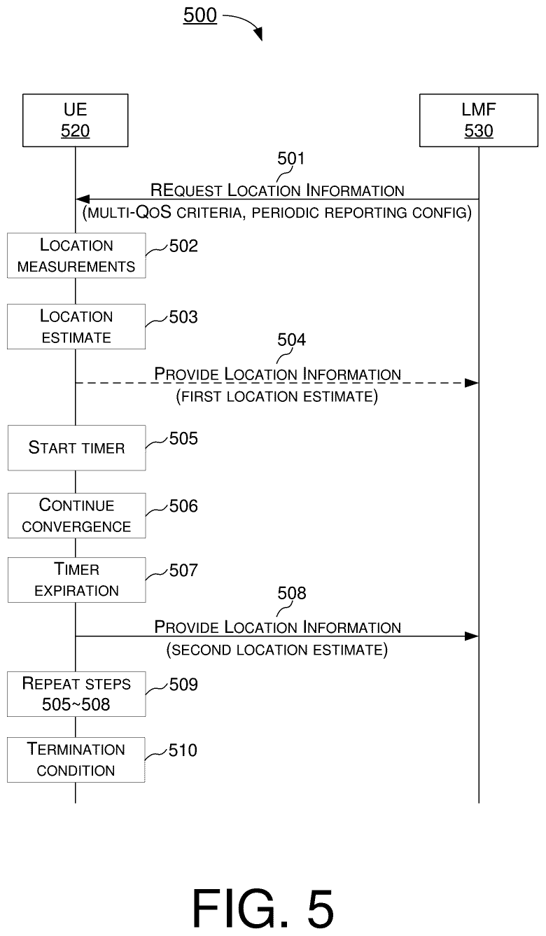

FIG. 5 illustrates an example scenario 500 of a positioning procedure with multiple QoS criteria in accordance with another implementation of the present disclosure. Scenario 500 depicts an exemplary message sequence chart of a positioning procedure involving a UE 520 configured by an LMF 530 to perform periodic reporting with multiple sets of QoS criteria. It is noteworthy that the steps of FIG. 5 may be considered as a replacement for steps 403 to 405 of FIG. 4, allowing the system to avoid the “lazy UE problem” in which a UE elides measurement and/or computation that achieves more stringent accuracy than the minimum (i.e., least stringent) accuracy requirement in a request. In step 501, the LMF 530 transmits to the UE 520 a request for location information (e.g., an LPP Request Location Information message), which contains multiple QoS criteria (e.g., at least a least stringent set of accuracy requirements and a most stringent set of accuracy requirements) and a periodic reporting configuration to configure the UE 520 for periodic reporting of its results. Each set of accuracy requirements may include a horizontal accuracy requirement and/or a vertical accuracy requirement. For example, the most stringent set of accuracy requirements may include a “horizontalAccuracy” information element (IE) indicating the maximum horizontal error in the location estimate at an indicated confidence level, and a “verticalAccuracy” IE indicating the maximum vertical error in the location estimate at an indicated confidence level and is only applicable when a vertical coordinate is requested. In addition, the least stringent set of accuracy requirements may include a “minimum HorizAccuracy” IE indicating the minimum (i.e., least stringent) horizontal accuracy for which the target device should report, and a “minimum VertAccuracy” IE indicating the minimum (least stringent) vertical accuracy for which the target device should report. The term “accuracy” may correspond to the encoded uncertainty as defined in 3GPP specifications and the term “confidence” may correspond to confidence as defined in 3GPP specifications.

Subsequently, in step 502, the UE 520 performs location measurements. In step 503, the UE 520 computes/determines a first location estimate. In step 504 (shown as an optional step in FIG. 5), the UE 520 may transmit a first location information message (e.g., an LPP Provide Location Information message) containing the first location estimate to the LMF 530. In step 505, the UE 520 starts a periodic reporting timer, whose duration may, e.g., be based on a reporting period configured in step 501. In step 506, the UE 520 performs further computations and/or measurements to support ongoing convergence of the location estimate (denoted as “Continue convergence” in FIG. 5). In step 507, after the passing of a certain amount of time, the timer that was started at step 505 expires. In step 508, the UE 520 transmits to the LMF 530 a second location information message (e.g., an LPP Provide Location Information message) containing a second location estimate which reflects the current degree of convergence of the positioning process at the UE 520. It may be expected that the second location estimate achieves better accuracy than the first location estimate. In step 509, the UE 520 repeats steps 505 to 508. That is, the UE 520 restarts the timer, continues converging its location estimates, and when the timer expires, it transmits to the LMF 530 a further location estimate representing its current degree of convergence. In step 510, a termination condition is met. The termination condition may include at least one of the following: (i) the achievement by the UE 520 of a location estimate meeting the most stringent QoS criteria from step 501; (ii) the expiration (or near-expiration) of a delivery deadline (e.g., a maximum response time, i.e., a period of time starting from the reception of the request in step 501) for a location estimate; (iii) the reception by the UE 520 of a message (e.g., an LPP Abort message) indicating that it should stop/terminate the positioning operation; and (iv) completion by the UE 520 of transmitting a configured number of periodic reports, etc.

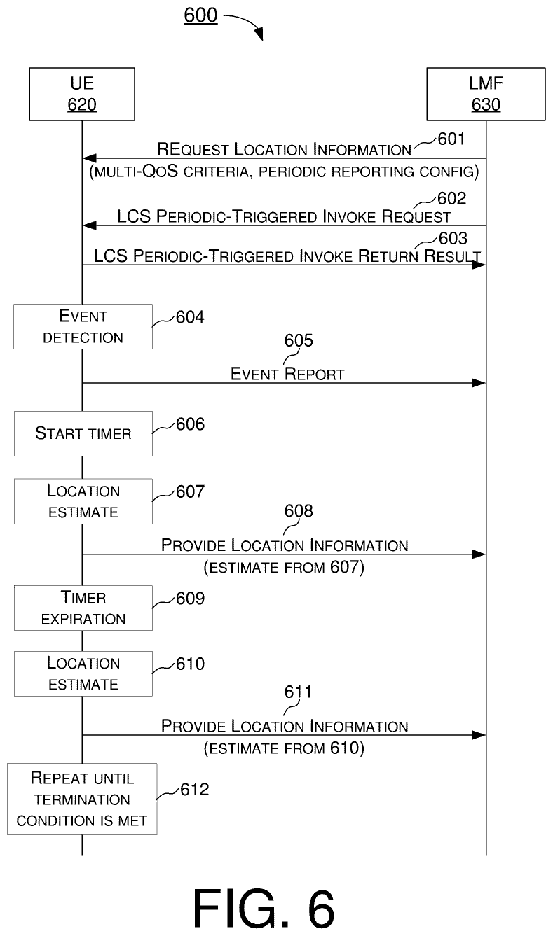

FIG. 6 illustrates an example scenario 600 of a positioning procedure with multiple QoS criteria in accordance with another implementation of the present disclosure. Scenario 600 depicts an exemplary message sequence chart of a positioning procedure involving a UE 620 configured by an LMF 630 with multiple QoS criteria and periodic reporting for a deferred MT-LR operation. In step 601, the LMF 630 transmits to the UE 620 a request for location information (e.g., an LPP Request Location Information message) containing a configuration of multiple QoS criteria and periodic reporting. In step 602, the LMF 630 transmits an LCS periodic-triggered invoke request to the UE 620, similar to step 302 of FIG. 3. In step 603, the UE 620 transmits an LCS periodic-triggered invoke return result to the LMF 630, to acknowledge that the deferred MT-LR event-triggered configuration has been accepted. In step 604, the UE 620 detects an event that triggers the deferred MT-LR reporting. In step 605, the UE 630 transmits an event report to the LMF 630, similar to steps 306 and 307 of FIG. 3). In step 606, the UE 620 starts a timer to support the requested periodic reporting, wherein the value of the timer may be the same as a requested periodicity of reporting. In step 607, the UE 620 computes/determines a first location estimate, which may be based, e.g., on location measurements performed by the UE 620 (which are not shown in FIG. 6). In step 608, the UE 620 reports the first location estimate to the LMF 630 via a location information message (e.g., an LPP Provide Location Information message). The first location estimate may be transmitted to the LMF 630, e.g., when the UE 620 achieves the least stringent one of the QoS criteria that were requested in step 601. In step 609, the periodic reporting timer expires. In step 610, the UE 620 computes/determines a second location estimate. In step 611, the UE 620 reports the second location estimate to the LMF 630 via a location information message (e.g., an LPP Provide Location Information message). The second location estimate may represent a further state of convergence in the location computations being performed at the UE 620, and it could be expected that the second location estimate would be more accurate than the first location estimate. In step 612, the UE 620 restarts the timer and repeats steps 609 to 611 until a termination condition is met. The termination condition may include at least one of the following: (i) achievement of the most stringent one of the QoS criteria that were provided in step 601; (ii) completion of a requested number of periodic reports; (iii) expiration (or near-expiration) of a requested delivery time (e.g., maximum response time) for the location estimate; (iv) reception of a message (e.g., an LPP Abort message) indicating that the UE 620 should stop/terminate the positioning operation, and so on.

### Illustrative Implementations

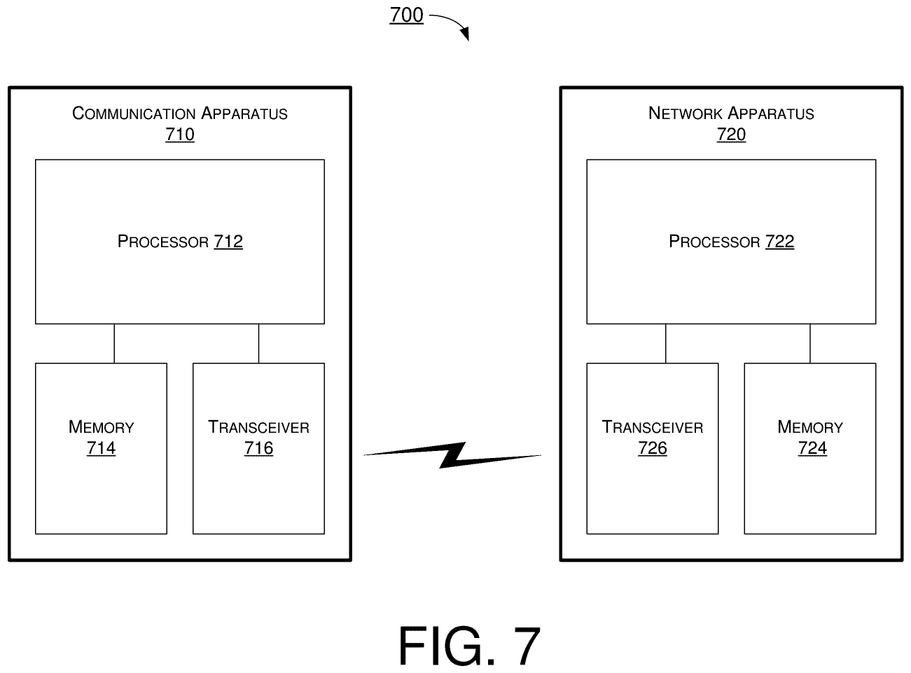

FIG. 7 illustrates an example communication system 700 having an example communication apparatus 710 and an example network apparatus 720 in accordance with an implementation of the present disclosure. Each of communication apparatus 710 and network apparatus 720 may perform various functions to implement schemes, techniques, processes and methods described herein pertaining to periodic reporting of location information with multiple QoS criteria in UE positioning, including scenarios/schemes described above as well as processes 800 and 900 described below.

Communication apparatus 710 may be a part of an electronic apparatus, which may be a UE such as a portable or mobile apparatus, a wearable apparatus, a wireless communication apparatus or a computing apparatus. For instance, communication apparatus 710 may be implemented in a smartphone, a smartwatch, a personal digital assistant, an electronic control unit (ECU) in a vehicle, a digital camera, or a computing equipment such as a tablet computer, a laptop computer or a notebook computer. Communication apparatus 710 may also be a part of a machine type apparatus, which may be an IoT, NB-IoT, enhanced machine-type communication (eMTC), IIoT UE such as an immobile or a stationary apparatus, a home apparatus, a roadside unit (RSU), a wire communication apparatus or a computing apparatus. For instance, communication apparatus 710 may be implemented in a smart thermostat, a smart fridge, a smart door lock, a wireless speaker or a home control center. Alternatively, communication apparatus 710 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 710 may include at least some of those components shown in FIG. 7 such as a processor 712, for example. Communication apparatus 710 may further include one or more other components not pertinent to the proposed schemes of the present disclosure (e.g., internal power supply, display device and/or user interface device), and, thus, such component(s) of communication apparatus 710 are neither shown in FIG. 7 nor described below in the interest of simplicity and brevity.

Network apparatus 720 may be a part of an electronic apparatus, which may be a network node/entity of a wireless network. For instance, network apparatus 720 may be implemented to function as a location server (e.g., LMF or SLP) in a 4G/5G/B5G/6G, IoT, NB-IoT or IIoT network. Alternatively, network apparatus 720 may be implemented in the form of one or more IC chips such as, for example and without limitation, one or more single-core processors, one or more multi-core processors, or one or more RISC or CISC processors. Network apparatus 720 may include at least some of those components shown in FIG. 7 such as a processor 722, for example. Network apparatus 720 may further include one or more other components not pertinent to the proposed scheme of the present disclosure (e.g., internal power supply, display device and/or user interface device), and, thus, such component(s) of network apparatus 720 are neither shown in FIG. 7 nor described below in the interest of simplicity and brevity.

In one aspect, each of processor 712 and processor 722 may be implemented in the form of one or more single-core processors, one or more multi-core processors, or one or more CISC processors. That is, even though a singular term “a processor” is used herein to refer to processor 712 and processor 722, each of processor 712 and processor 722 may include multiple processors in some implementations and a single processor in other implementations in accordance with the present disclosure. In another aspect, each of processor 712 and processor 722 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 712 and processor 722 is a special-purpose machine specifically designed, arranged and configured to perform specific tasks, including periodic reporting of location information with multiple QoS criteria in UE positioning, in a UE (e.g., as represented by communication apparatus 710) and a location server (e.g., as represented by network apparatus 720) in accordance with various implementations of the present disclosure.

In some implementations, communication apparatus 710 may also include a transceiver 716 coupled to processor 712 and capable of wirelessly transmitting and receiving data. In some implementations, transceiver 716 may be capable of wirelessly communicating with different types of UEs and/or wireless networks of different radio access technologies (RATs). In some implementations, transceiver 716 may be equipped with a plurality of antenna ports (not shown) such as, for example, four antenna ports. That is, transceiver 716 may be equipped with multiple transmit antennas and multiple receive antennas for multiple-input multiple-output (MIMO) wireless communications. In some implementations, network apparatus 720 may also include a transceiver 726 coupled to processor 722. Transceiver 726 may include a transceiver capable of wired data transmissions and receptions with other network nodes/entities (e.g., RAN, AMF, and GMLC, etc.), through which communications with UEs of different RATs may be achieved.

In some implementations, communication apparatus 710 may further include a memory 714 coupled to processor 712 and capable of being accessed by processor 712 and storing data therein. In some implementations, network apparatus 720 may further include a memory 724 coupled to processor 722 and capable of being accessed by processor 722 and storing data (e.g., URSP rules) therein. Each of memory 714 and memory 724 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 714 and memory 724 may include a type of read-only memory (ROM) such as mask ROM, programmable ROM (PROM), erasable programmable ROM (EPROM) and/or electrically erasable programmable ROM (EEPROM). Alternatively, or additionally, each of memory 714 and memory 724 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 710 and network apparatus 720 may be a communication entity capable of communicating with each other using various proposed schemes in accordance with the present disclosure. For illustrative purposes and without limitation, a description of capabilities of communication apparatus 710, as a UE, and network apparatus 720, as a location server (e.g., LMF or SLP), is provided below with processes 800 and 900.

### Illustrative Processes

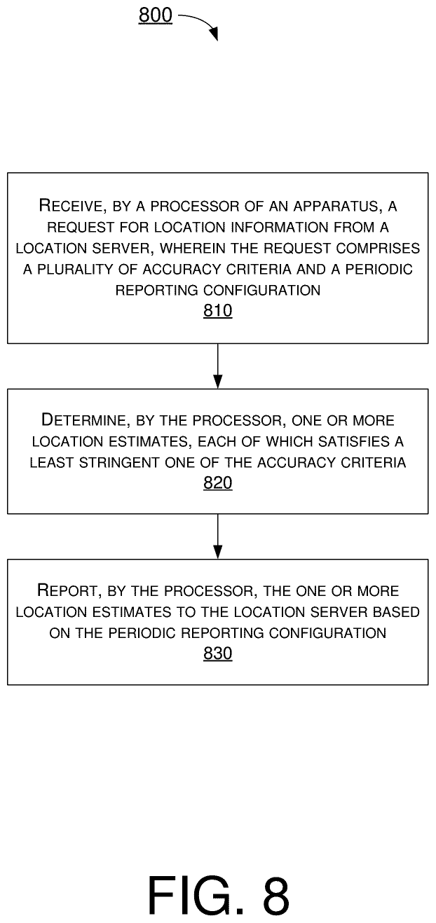

FIG. 8 illustrates an example process 800 in accordance with an implementation of the present disclosure. Process 800 may represent an aspect of implementing various proposed designs, concepts, schemes, systems and methods described above, whether partially or entirely, including those described above. More specifically, process 800 may represent an aspect of the proposed concepts and schemes pertaining to periodic reporting of location information with multiple QoS criteria in UE positioning. Process 800 may include one or more operations, actions, or functions as illustrated by one or more of blocks 810 to 830. Although illustrated as discrete blocks, various blocks of process 800 may be divided into additional blocks, combined into fewer blocks, or eliminated, depending on the desired implementation. Moreover, the blocks/sub-blocks of process 800 may be executed in the order shown in FIG. 8 or, alternatively in a different order. Furthermore, one or more of the blocks/sub-blocks of process 800 may be executed iteratively. Process 800 may be implemented by or in communication apparatus 710 and network apparatus 720 as well as any variations thereof. Solely for illustrative purposes and without limiting the scope, process 800 is described below in the context of communication apparatus 710 as a UE and network apparatus 720 as a location server. Process 800 may begin at block 810.

At 810, process 800 may involve processor 712 of communication apparatus 710, implemented in or as a UE, receiving, via transceiver 716, a request for location information from a location server (e.g., network apparatus 720), wherein the request comprises a plurality of accuracy criteria and a periodic reporting configuration. Process 800 may proceed from 810 to 820.

At 820, process 800 may involve processor 712 determining one or more location estimates, each of which satisfies a least stringent one of the accuracy criteria. Process 800 may proceed from 820 to 830.

At 830, process 800 may involve processor 712 reporting, via transceiver 716, the one or more location estimates to network apparatus 720 based on the periodic reporting configuration.

In some implementations, the one or more location estimates may include one or more first location estimates, each of which does not satisfy a most stringent one of the accuracy criteria.

In some implementations, the one or more location estimates may include a second location estimate which satisfies the most stringent one of the accuracy criteria.

In some implementations, the one or more location estimates may include a single location estimate which satisfies a most stringent one of the accuracy criteria.

In some implementations, process 800 may further involve processor 712 terminating the reporting of the one or more location estimates in an event that a termination condition is met.

In some implementations, the termination condition comprises at least one of the following: (i) one of the reported one or more location estimates satisfies a most stringent one of the accuracy criteria; (ii) a number of reported location estimates have been reached; (iii) a period of time (e.g., maximum response time) from the reception of the request has elapsed; and (iv) a message indicating a termination of the reporting of the one or more location estimates is received from the location server.

In some implementations, the location server may include an LMF or an SLP.

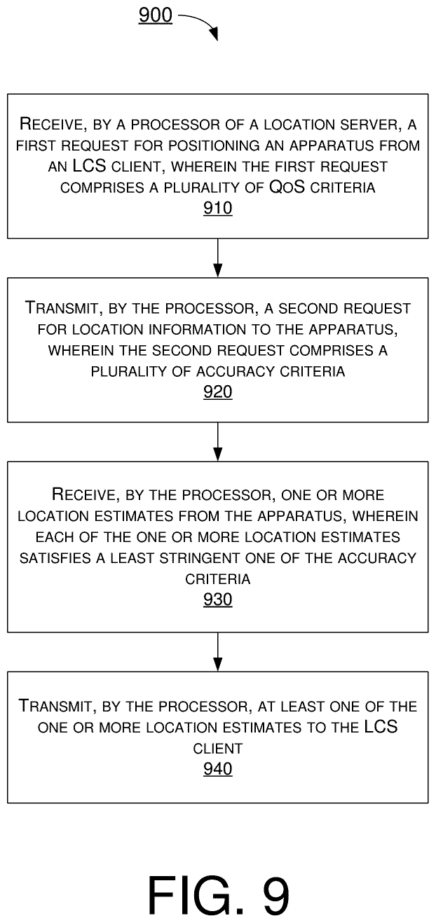

FIG. 9 illustrates an example process 900 in accordance with an implementation of the present disclosure. Process 900 may represent an aspect of implementing various proposed designs, concepts, schemes, systems and methods described above, whether partially or entirely, including those described above. More specifically, process 900 may represent an aspect of the proposed concepts and schemes pertaining to periodic reporting of location information with multiple QoS criteria in UE positioning. Process 900 may include one or more operations, actions, or functions as illustrated by one or more of blocks 910 to 940. Although illustrated as discrete blocks, various blocks of process 900 may be divided into additional blocks, combined into fewer blocks, or eliminated, depending on the desired implementation. Moreover, the blocks/sub-blocks of process 900 may be executed in the order shown in FIG. 9 or, alternatively in a different order. Furthermore, one or more of the blocks/sub-blocks of process 900 may be executed iteratively. Process 900 may be implemented by or in communication apparatus 710 and network apparatus 720 as well as any variations thereof. Solely for illustrative purposes and without limiting the scope, process 900 is described below in the context of communication apparatus 710 as a UE and network apparatus 720 as a location server. Process 900 may begin at block 910.

At 910, process 900 may involve processor 722 of network apparatus 720, implemented in or as a location server, receiving, via transceiver 726, a first request for positioning an apparatus (e.g., communication apparatus 710) from an LCS client, wherein the first request comprises a plurality of QoS criteria. Process 900 may proceed from 910 to 920.

At 920, process 900 may involve processor 722 transmitting, via transceiver 726, a second request for location information to communication apparatus 710, wherein the second request comprises a plurality of accuracy criteria. Process 900 may proceed from 920 to 930.

At 930, process 900 may involve processor 722 receiving, via transceiver 726, one or more location estimates from communication apparatus 710, wherein each of the one or more location estimates satisfies a least stringent one of the accuracy criteria. Process 900 may proceed from 930 to 940.

At 940, process 900 may involve processor 722 transmitting, via transceiver 726, at least one of the one or more location estimates to the LCS client.

In some implementations, the accuracy criteria may be derived from the QoS criteria.

In some implementations, the one or more location estimates may include one or more first location estimates, each of which does not satisfy a most stringent one of the accuracy criteria.

In some implementations, the one or more location estimates may include a second location estimate which satisfies the most stringent one of the accuracy criteria.

In some implementations, the one or more location estimates may include a single location estimate which satisfies a most stringent one of the accuracy criteria.

In some implementations, the location server may include an LMF or an SLP.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a request for location information from a location server, wherein the request comprises a plurality of accuracy criteria and a periodic reporting configuration;
determining, by the processor, one or more location estimates, each of which satisfies a least stringent one of the accuracy criteria; and
reporting, by the processor, the one or more location estimates to the location server based on the periodic reporting configuration.

2. The method of claim 1, wherein the one or more location estimates comprise one or more first location estimates, each of which does not satisfy a most stringent one of the accuracy criteria.

3. The method of claim 2, wherein the one or more location estimates comprise a second location estimate which satisfies the most stringent one of the accuracy criteria.

4. The method of claim 1, wherein the one or more location estimates comprise a single location estimate which satisfies a most stringent one of the accuracy criteria.

5. The method of claim 1, further comprising:
terminating, by the processor, the reporting of the one or more location estimates in an event that a termination condition is met.

6. The method of claim 5, wherein the termination condition comprises at least one of the following:
one of the reported one or more location estimates satisfies a most stringent one of the accuracy criteria;
a number of reported location estimates have been reached;
a period of time from the reception of the request has elapsed; and
a message indicating a termination of the reporting of the one or more location estimates is received from the location server.

7. The method of claim 1, wherein the location server comprises a location management function (LMF) or a secure location platform (SLP).

8. An apparatus, comprising:
a transceiver which, during operation, wirelessly communicates with a wireless network comprising a location server; and
a processor communicatively coupled to the transceiver such that, during operation, the processor performs operations comprising:
receiving, via the transceiver, a request for location information from the location server, wherein the request comprises a plurality of accuracy criteria and a periodic reporting configuration;
determining one or more location estimates, each of which satisfies a least stringent one of the accuracy criteria; and
reporting, via the transceiver, the one or more location estimates to the location server based on the periodic reporting configuration.

9. The apparatus of claim 8, wherein the one or more location estimates comprise one or more first location estimates, each of which does not satisfy a most stringent one of the accuracy criteria.

10. The apparatus of claim 9, wherein the one or more location estimates comprise a second location estimate which satisfies the most stringent one of the accuracy criteria.

11. The apparatus of claim 8, wherein the one or more location estimates comprise a single location estimate which satisfies a most stringent one of the accuracy criteria.

12. The apparatus of claim 8, wherein, during operation, the processor further performs operations comprising:
terminating the reporting of the one or more location estimates in an event that a termination condition is met.

13. The apparatus of claim 12, wherein the termination condition comprises at least one of the following:
one of the reported one or more location estimates satisfies a most stringent one of the accuracy criteria;
a number of reported location estimates have been reached;
a period of time from the reception of the request has elapsed; and
a message indicating a termination of the reporting of the one or more location estimates is received from the location server.

14. The apparatus of claim 8, wherein the location server comprises a location management function (LMF) or a secure location platform (SLP).

15. A method, comprising:
receiving, by a processor of a location server, a first request for positioning an apparatus from a location services (LCS) client, wherein the first request comprises a plurality of quality-of-service (QOS) criteria;
transmitting, by the processor, a second request for location information to the apparatus, wherein the second request comprises a plurality of accuracy criteria;
receiving, by the processor, one or more location estimates from the apparatus, wherein each of the one or more location estimates satisfies a least stringent one of the accuracy criteria; and
transmitting, by the processor, at least one of the one or more location estimates to the LCS client.

16. The method of claim 15, wherein the accuracy criteria are derived from the QoS criteria.

17. The method of claim 15, wherein the one or more location estimates comprise one or more first location estimates, each of which does not satisfy a most stringent one of the accuracy criteria.

18. The method of claim 17, wherein the one or more location estimates comprise a second location estimate which satisfies the most stringent one of the accuracy criteria.

19. The method of claim 15, wherein the one or more location estimates comprise a single location estimate which satisfies a most stringent one of the accuracy criteria.

20. The method of claim 15, wherein the location server comprises a location management function (LMF) or a secure location platform (SLP).
